(19) United States
(12) Patent Application Publication
(10) Pub. No.: US 2009/0216806 A1
(43) Pub. Date: Aug. 27, 2009

(54) DIGITAL ASSETS INTERNET TIMELINE AGGREGATION AND SHARING PLATFORM

(75) Inventors: Addy FEUERSTEIN, Tel-Aviv (IL); Tal YANIV, Holon (IL); Oded YUNGER, Tel-Aviv (IL); Guy Moshe LEVITAN, Herzlia (IL); Erez HUBERMAN, Ramat Gan (IL)

Correspondence Address: SCULLY SCOTT MURPHY & PRESSER, PC, 400 GARDEN CITY PLAZA, SUITE 300, GARDEN CITY, NY, 11530, US

(73) Assignee: ALLOFME LTD., Tel-Aviv (IL)

(21) Appl. No.: 12/129,226

(22) Filed: May 29, 2008

(30) Foreign Application Priority Data
Feb. 24, 2008 (IL) 189695

(51) Int. Cl. G06F 17/30

(52) U.S. Cl. 707/104.1; 707/E17.005

(57) ABSTRACT

Personal digital assets are collected, managed, shared and archived on a social network using a client interface for registering a user and performing tasks. User sources are defined and assets are collected and organized chronologically as eternal Time-lines. Permission level rules are associated with each asset and Time-line and a plurality of subjective groups distinguished by their relation to the user are defined. Chosen assets of the Time-line are tagged with assigned keywords recognized by the social network service, thus sharing them with the tagged entity according to the permission level rules. Authorized members are invited to contribute and share assets with the founder of an established Time-line, and data storage is optimized in a way that every tag added to an assets appears on every instance it has on other Time-lines sharing that asset, such that shared assets are saved to the data storage only once.

### FIELD OF THE INVENTION

The present invention relates to collecting, managing and secure sharing of personal digital information on a social network, and more particularly to a method and system of archiving assortment of digital media formats and external links, collectively forming personal life-time identity, on a single social network.

### BACKGROUND OF THE INVENTION

Since the third century, when paper became the main substance for writing, and until the end of the 20th century, starting the age of personal computing, the only way to keep personal information such as letters, official documents and sketches or photos was on paper. The amount of personal paper documents was limited and an individual could save his entire lifetime documentation in a moderate storage box. The introduction of digital media and storage devices made it possible to save more frequent and detailed information such as audio and video streams, digital or scanned paper documents, as well as text files and still images. The rapid technology improvement, however, made it difficult to follow-up, as VCR tapes, audio cassettes and floppy disks were replaced with more efficient devices and equipment to read such media is rapidly becoming rare. An individual must be aware and keep transforming to the newer formats before the data becomes unreadable, furthermore backups must be made periodically, in order to assure that the information will be safe in case of a hardware crash. Such transformations and backups sometimes require technical skills not common to the private user. As a result public and commercial organizations such as Google, AOL, Yahoo, Hotmail, etc., now provide world wide web storage services with search options and some limited assurance to its future validity (services). Other, category-specific services, provide sharing of video streams, pictures and audio, such as YouTube Google's Picasa, Flicker, Myspace, etc.

Whether using the local (off-line) storage approach or the services (on-line) storage approach, the huge amount of information and the different categories by which such information is collected, makes it very difficult to locate a specific item. The data collection and spreading channels may include: email attachments, off-line desktop applications, on-line storage websites, blogs, photo sharing websites, video sharing websites, audio sharing websites, scanned hard-copies and more. Such deficient spreading is, however not reversible, and the more channels used to store and share digital media, the more difficult it becomes to trace it back. For instance, tracing a particular wedding photo, which a friend had sent to an obsolete e-mail address may become a time-consuming task or totally fail. Even if a particular item such as photo is located, there are no means to associate that photo with other photos of the same event, stored in a photo-sharing website, or to share them together with the poem that was read during that same ceremony, stored on an old computer's hard-drive. These valuable assets are just spread all over and may eventually be lost.

In order to improve efficiency and reduce storage amount, most of the on-line services offer an option to “share” the digital assets, either with a selected group of family and friends, using access control such as password protection, or by publishing them entirely to the public domain so that every visitor to that Internet site can view them, optionally tag them with keywords, and comment on them. When, however, these services offer “sharing”, the meaning is actually “publishing” e.g., when a user is sharing a picture of his newborn son with his family and friends, that picture doesn't become part of the visitors own personal collection of digital assets. In particular, that picture doesn't become a part of his son's private collection, so that when his son grows up, he will have no way of accessing the asset, unless he knows exactly where it is published, and has a granted access to that particular service.

One may claim that e-mail offers a “true” sharing experience, when sent with an attached digital file, so that file becomes part of the recipient's inventory. This is partly true, however, the e-mail concept, actually duplicates the file, creating a copy of it. The sent copy is totally separate from the original one, and therefore, if the original copy is tagged with a keyword, the keyword is not associated with the sent copy. In other words, an e-mail attachment offers another means of publishing, and not a “true” sharing experience.

As of today, there is not one unified system that enables us to manage, maintain, monitor and share all of these assets in an interactive chronological fashion, regardless of their origin, digital file type and format.

### SUMMARY OF THE INVENTION

It is thus an object of the present invention to devise a method and provide a system for long-term collecting, managing, secure sharing and archiving of valuable personal digital assets on a social network.

In accordance with one embodiment of the present invention, there is provided a method comprising:

a. providing at least an on-line social network service, having at least one dispatcher application and storage capabilities;

b. providing a client interface;

c. using the client interface for becoming registered user of the social network service;

d. using the client interface for defining user sources and collect assets, the collected assets are chronologically organized as eternal Time-lines;

e. using the client interface for setting permission level rules associated with each asset and Time-line;

f. using the client interface for defining plurality of subjective groups distinguished by their relation to the user, and occupying each group with keywords assigned to its individual entities;

g. using the client interface for tagging chosen assets of the Time-line, with the assigned keywords, recognized by the social network service, thus sharing them with the tagged entity according to the permission level rules;

h. inviting and enabling authorized members to contribute and share assets with the founder of an established Time-line, and

i. optimizing the stored data, in a way that every tag added to an assets will appear on every instance it has on other Time-lines sharing that asset, such that shared assets will be saved to the data storage only once.

Additionally, according to one embodiment, there is provided a system configured to perform the above method, comprising:

a. a collection of digital assets stored on devices chosen at least from the list of: storage services; local disks; websites; dedicated social networks; address-books; contacts-lists; backup devices;

b. a social network service Internet site established and brought on-line;

c. at least one dispatcher application responsible for synchronization with said collection storage devices;

d. storage repository;

e. at least one end device with Internet access;

f. a client interface application with registration and log-in screens; and

g. additional service specific menus chosen at least from the list of: Services, Time-lines; Contacts; Shares; or Assets.

### BRIEF DESCRIPTION OF THE DRAWINGS

The invention will now be described in connection with certain embodiments with reference to the following illustrative figures so that it may be more fully understood.

With specific reference now to the figures in detail, it is stressed that the particulars shown are by way of example and for purpose of illustrative discussion of the embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a flow chart generally describing the relation of component in accordance with an embodiment of the present invention;

FIG. 2 is a flow chart describing the client interface menus according to the embodiment of FIG. 1;

FIG. 3 is a screen image demonstrating the client interface application;

FIG. 4 demonstrates an asset-fetching process, showing a selection window;

FIG. 5 is a sample of an asset summary window, and

FIG. 6 is a sample of Time-line screen image with a zoom option.

### DETAILED DESCRIPTION OF EMBODIMENTS

In accordance with one embodiment of the present invention, and with reference to the drawings, a method and system of long-term collecting, managing, secure sharing and archiving of valuable personal digital assets on a social network is provided. The method will be described by the operations taken for achieving its goals.

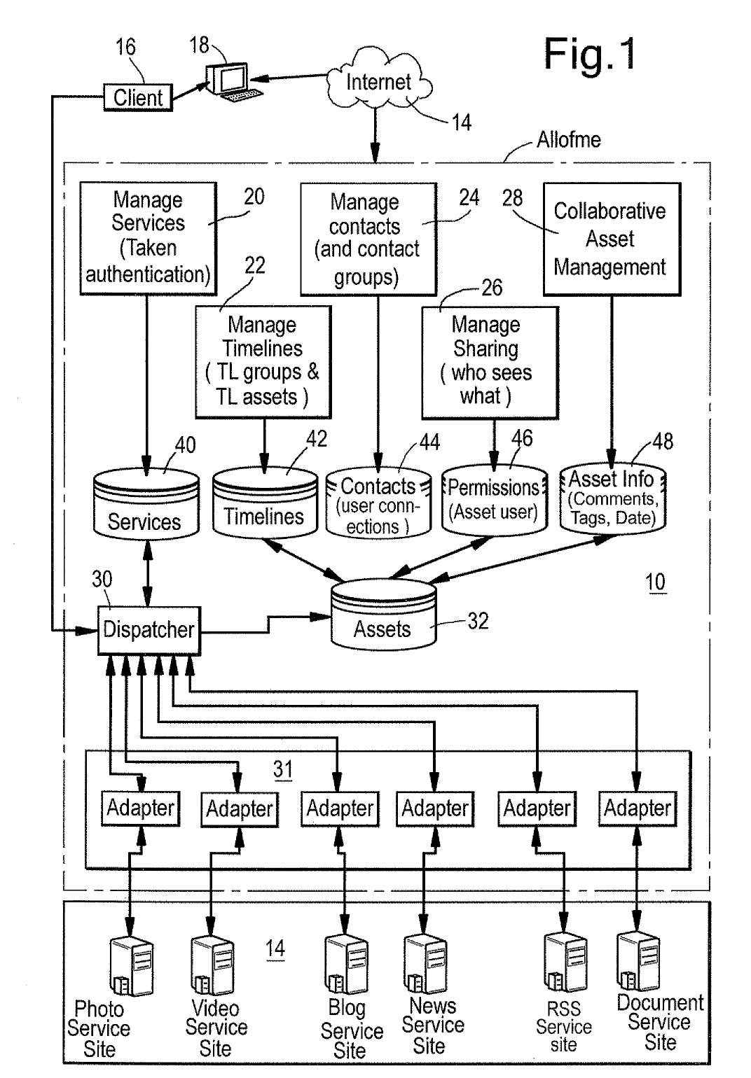

The first operation includes providing at least an on-line service (AllofMe-service), such as social network Internet site 10 (FIG. 1), having dispatcher application 30, optional fetcher application 31, and storage capabilities 32.

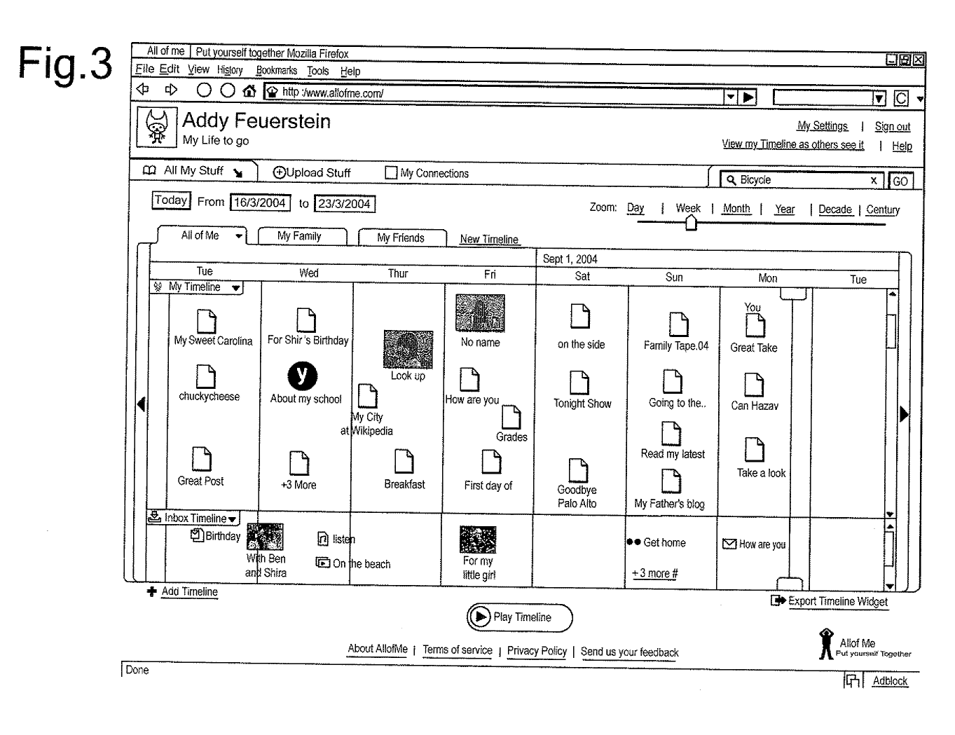

A second operation includes providing a client interface 16, such as on-line interface application located on the service, appearing to the user as website pages and forms (FIG. 3), or as a locally installed application program (AllofMe-client).

The third operation includes using the client interface 16 (AllofMe-client) for becoming registered user of the social network service 10 (AllofMe-service).

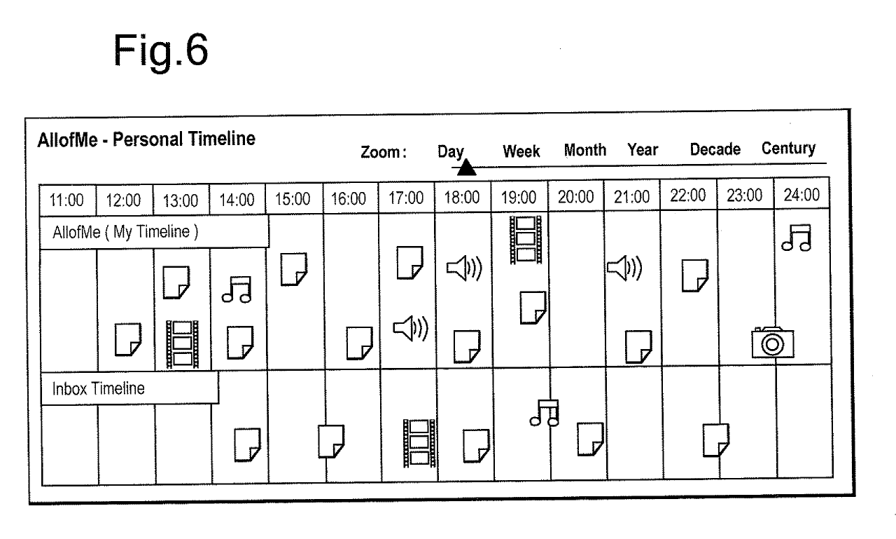

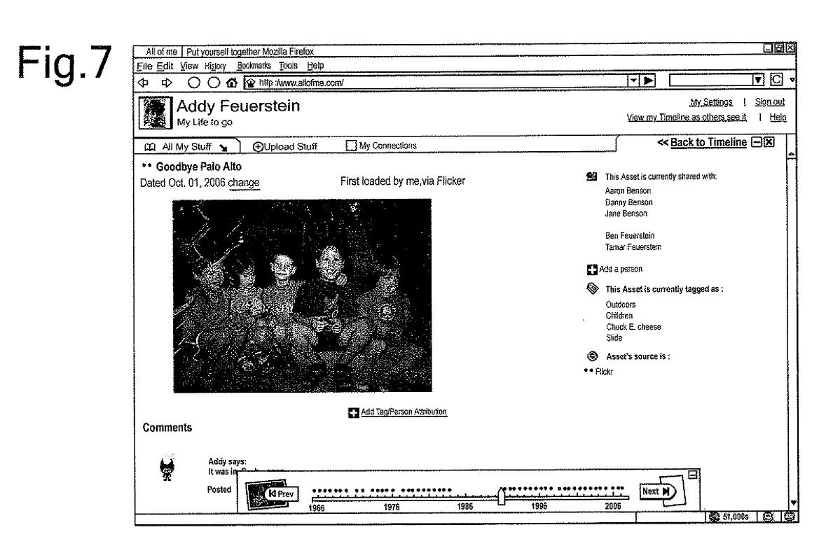

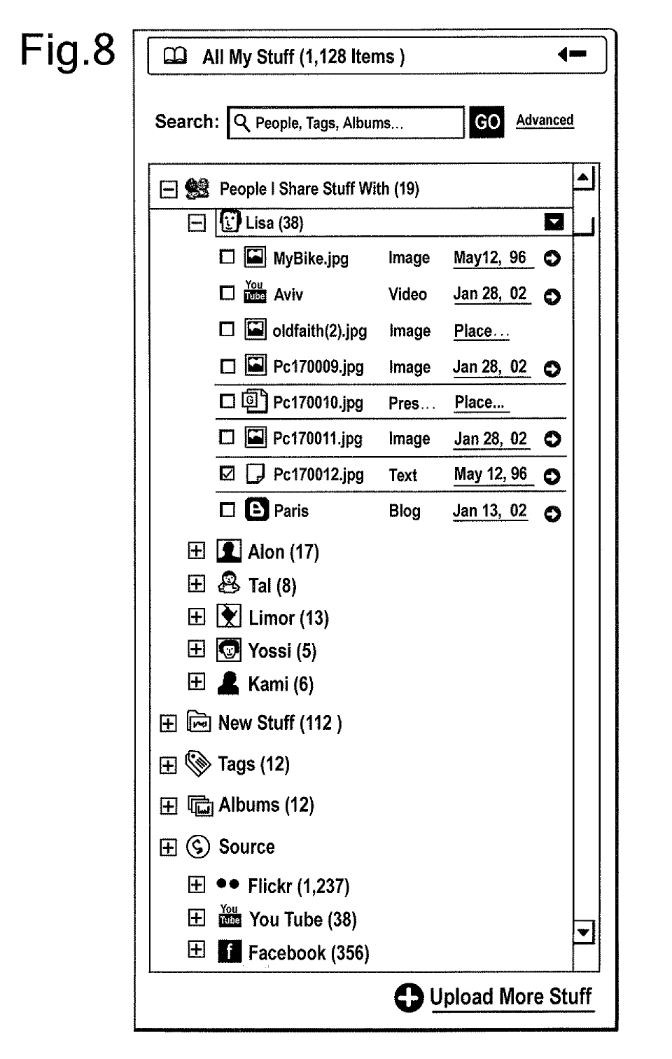

The fourth operation includes using the client interface 16 for defining user sources, such as Internet existing services 14, Internet websites, local files, folders, E-mails, address books and external links. AllofMe-service preferably mirrors live content and keeps track of changes. The collected assets are chronologically organizing as an eternal Time-line (FIGS. 3, 6) for easy future access from the Time-line storage repository 42. A user may create a plurality of Time-lines for various reasons, as will be explained hereinafter. On-screen visibility of a Time-line may be zoomed by the user on the client interface (FIG. 6), from one day in life to entire life time, or any other desirable period of time, optionally, rolled as a movie presentation with speed control.

Optionally, the service fetcher application program 31 may perform automatic seamless scheduled task of assets collection from user-defined sources. For instance, if the user is a registered Flickr user, it can be defined as one source to the user's collection, and AllofMe fetcher, will scan the user's Flickr account consistently, so that each asset added to the user's Flickr photo album will automatically become part of that user's AllofMe collection. In a similar manner, the user can aggregate data from other online services, such as Goggle's Picasa web albums (pictures), YouTube (videos), or Scribd (documents), to name a few. User account identities and security passwords for the existing sources may be encrypted and stored by the client application program locally, or by the service application on services storage repository 40. The data is used for automatic scheduled scanning of existing sources for new added assets and for fetching those to be part of the user's stored data.

The fifth operation includes setting permission level rules associated with each asset, Time-line or group, thus granting certain privileges to others, such that privileged visitors will be able to view an asset or entire Time-line anytime in the future. For example, a great-grand child would be able to view images of his grand-grandparent's wedding, just by the grandparent granting this privilege to his successors individually or by setting appropriate permission level rules to its “successors” group. Optionally when setting Time-line permission level rules, certain assets of that Time-line may have different permission level rules overriding the Time-line permission level rules. The set permissions are stored on the service permissions repository 46.

The sixth operation includes defining a plurality of subjective groups distinguished by their relation to the user, such as family group, friends group, colleagues group, sports group, etc., and occupying each group with keywords assigned to its individual entities, such as personal Email addresses or names assigned to these entities on the social network, being persons, Time-lines or assets. The assigned keywords and entities are stored on the service contacts repository 44.

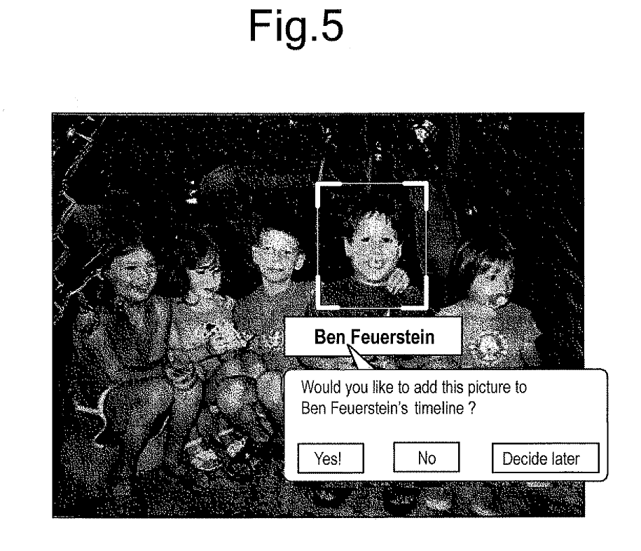

The seventh operation includes using the client interface 16 for tagging assets in a Time-line with previously assigned keyword (FIG. 5), now recognized by AllofMe-service, thus linking and sharing them with others, members or not members of the social network, according to the associated permission level rules. For example, when a first member tags an image showing a second person, with that second person assigned keyword, and the permission level rules allow, the image is immediately shared with the tagged second person. If the second person is not a member of the social network, that second person receives an E-mail notifying that an asset was added to his/hers virtual Time-line on the social network. That second person can claim it at any given time by becoming a registered member of the social network service 10. Tags may link to specific group of users by using a group entity assigned keyword, for instance “friends”, thus sharing an asset with the entire group members. A tag may include, for example, an attribute, comment or reminder note such as: “this is my uncle”. Tags and their attributes are stored in the asset-info storage repository 48.

The eighth operation includes inviting and enabling authorized members to contribute and share assets with the founding member of an established Time-line, while the founder decides what to accept. Such Time-line will quickly be filled up with life bytes: joint pictures with family, videos with friends, essays, blog-posts, etc. The system can mirror any web page so each member can easily share assets that are published on different websites. Each asset can be tagged and shared with other people's Time-lines, so the end result is a collective time-related data storage, where people can look back into their life's records Time-line, or view them as a movie via AllofMe widgets.

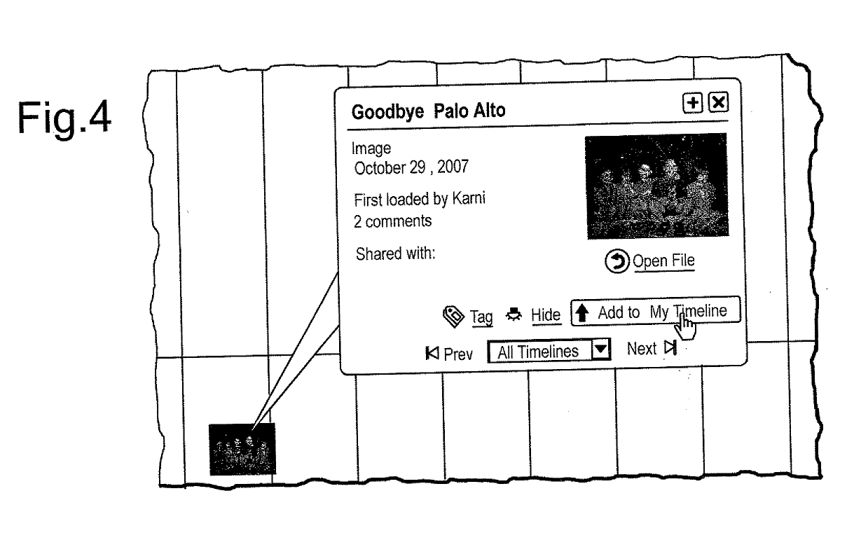

The ninth operation includes optimizing the stored data such that shared assets will be saved only once. Every comment or tag made to an asset will appear on every instance it has on other people's Time-lines, as well. There is only one shared copy of each item, so the more information joined to that item, the more people will share it. For example, with reference to FIGS. 3, 4 and 5, in a mutual trip, a first participant has taken a picture of a second participant's kids with the first participant's kids. The first participant uploaded the picture to an existing on-line service, and by being an AllofMe user, that picture has been automatically fetched and appeared on the first participant's own personal collection and Time-line. (In a similar manner, the picture could be uploaded directly to the first participant's AllofMe account). Thereafter, using AllofMe-client, that picture was tagged with “friends” group keyword. Now, assuming that the second participant is also an AllofMe user, and they both appear in each others “friends” group, then, once the picture is tagged by the first participant with “friends” keyword, the second participant will get a notification (FIG. 4) suggesting to add that picture to his/her timeline as well, it will appear under the new stuff title FIG. 8). The picture is not copied, it is added as a link to the original asset itself, stored in the main asset repository 32. This means that now the second participant has subscribed to the same picture, wherever its source may be. Every tag, or comment added to this picture, will appear in the Time-line of both participants. For instance, the second user can open the picture, and add a comment: “my son's head” on it with some marling, such as a directing arrow, while tagging his son's name and adding an optional title “this is Ben”. Now by tagging with Ben's name, the same picture will appear on Ben's Time-line as well, and will be a part of his collection. In Addition, everybody who shared the picture will be able to see the new title and know that this is Ben.

The disclosed method generally puts the individual user in the center, building up circles of sharing privileges around the individual. This is different from other social networks, which focus on the network rather than the individual. The service will enable a user to aggregate assets from various hosts, combining online hosts such as Google's Picasa web, Flickr, Myspace, etc., with personal assets such as e-mails, presentations and other files. The service will allow backing-up, securing and insuring assets of all individuals for a long period of time, so they can be transmitted from one generation to the other.

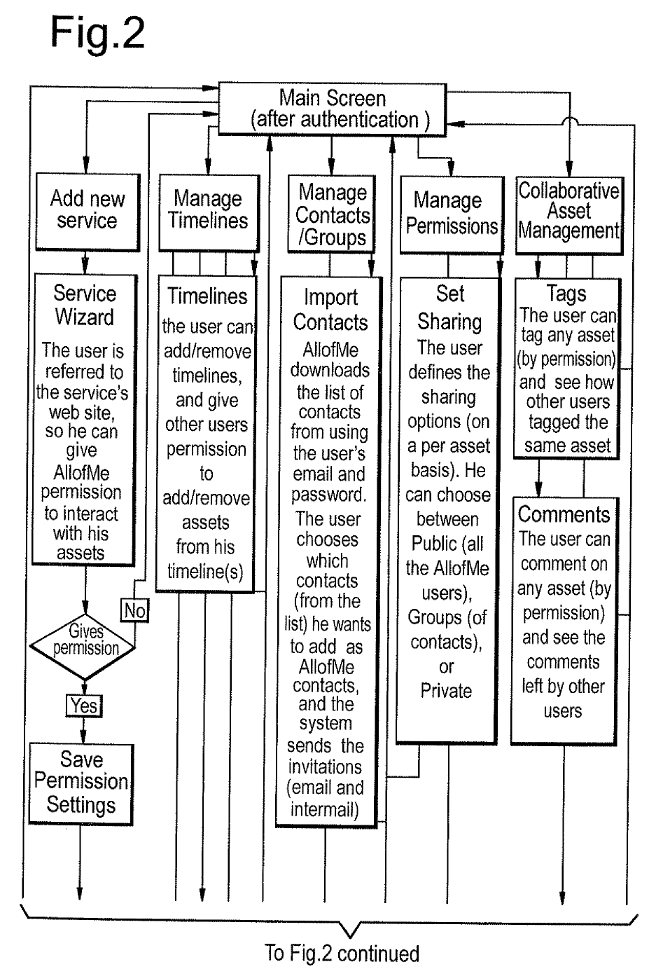

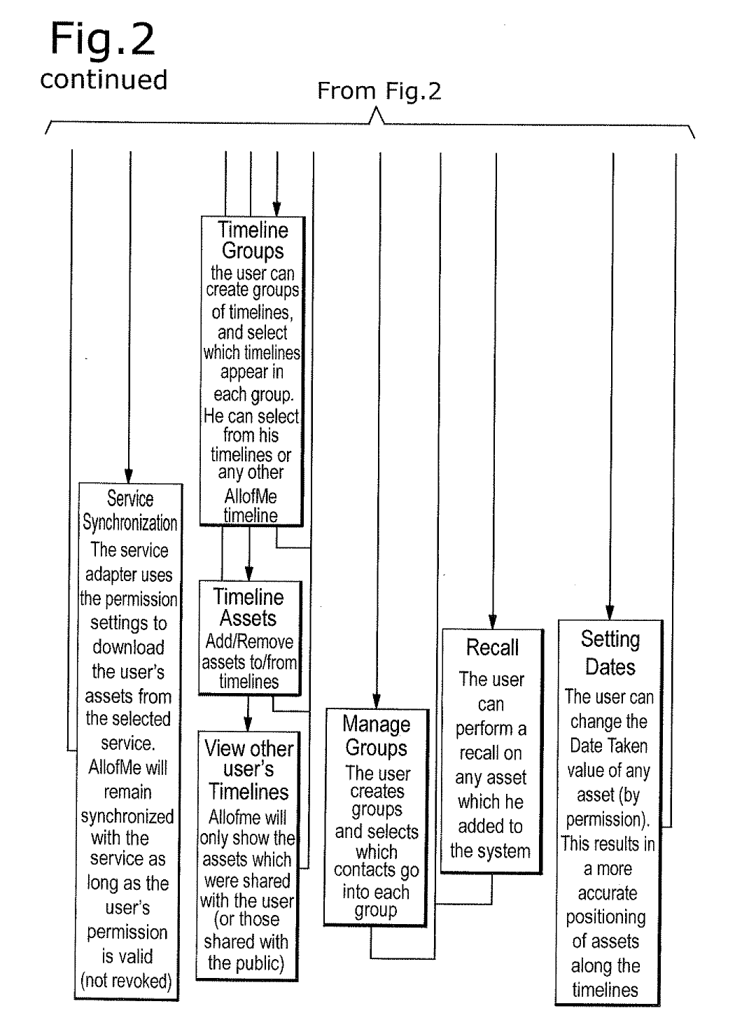

In practice, with reference to FIGS. 1 and 2, a collection of digital assets is located on storage devices such as: local disks, email service providers, websites, dedicated social networks, address books, contacts-lists, backup devices. A social network service (AllofMe website) generally referenced 10 is established and brought on-line, including at least a dispatcher application 30 responsible for synchronization with the above storage devices, and data storage repository 32.

A user operating end device 18 such as a computer, cell phone, terminal, etc., properly equipped for Internet access, may use an on-line client interface 16 such as website pages, menus and forms, or download and install a local client application, (AllofMe client interface). The client application is treated by AllofMe-service dispatcher 30 as one of the mentioned storage devices, with continuous synchronization uploading newly added pictures, video and so on, into the user's AllofMe account, as will be hereinafter explained.

The user registers, if new to the social network service, or logs in if already registered. The client interface application 16, is operative through navigation menus, on main screen 60, available menus may include: Services 20,50, Time-lines 22,52, Contacts 24,54, Shares 26,56, Assets 28, 58. Other menus may be added or modified periodically as needed or requested by users.

On the Services menu 50, the user passes to AllofMe-dispatcher 30, authentications and identifications (token authentication) required to access his data on the storage devices for instance: files on storage services, pictures on Picasa, his Blog on Blogger, etc. The Dispatcher 30, is responsible for synchronizing the services as long as there is a valid authentication. Upon confirmation by the user, the authentications are saved locally to the end device 18, or to the service repository 40, for future seamless scheduled automatic synchronization task of assets collection. The collection task is performed by a fetcher application 31 on the service.

On the Time-lines menu 59, the user creates or manages tabbed branches and assigns assets to them, chronologically organized and visualized as Time-lines (FIGS. 3,6), optionally granting other users permission to manage or view assets appearing on the user's Time-line.

The user can associate different Time-lines to previously defined distinguished groups (such as “my old cars” group), as will be hereinafter explained, those may be visually represented as tabs in his/hers page on the service website (FIG. 3). Each group may contain several Time-lines from multiple users, and even multiple Time-lines from the same user, optionally having different permission level rules. Time-lines can also be edited by multiple users simultaneously, enabling the creation of collaborative Time-line projects (Time magazine covers, US presidents, etc.).

Additionally, on the Time-lines menu users or members of the social network service, may view or manage other Time-lines according to the permission level rules associated with those Time-lines, accordingly, some Time-lines may have free access to all users and guests. The Time-line visualization permits various resolution zooming from one day to life-time or any desired period of time (FIG. 6), optionally, horizontally or vertically scrolled as a movie presentation with speed control.

On the Contacts menu 54, the user can import the list of contacts from the above-mentioned storage devices, such as his e-mail account (Gmail, Yahoo, Hotmail, etc.). AllofMe service will break the list into contacts which are already AllofMe users, and those who are not. The user can choose to offer friendship to AllofMe members, and invite those who aren't members to join AllofMe. The user can assign keyword to each contact and create or manage groups of contacts (Friends, Family, Co-workers, etc.) populated with the contacts and assigned keywords. Groups may also be assigned with keywords, visually represented as tabs in the user's page on the social network service website.

On the Share menu 56, the user can set asset, Time-line or group specific permission level rules by filling a permission field bound to each asset of the Time-line, the entire Time-line, or group, with a permission level rule, defining who else can view or edit the asset itself and its related details, such as linking tags and comments, for all the assets the user owns (that he added to AllofMe, or those that were shared with him). The user can decide to make an asset Public (viewable by all the AllofMe users and guests), share it with his “friends” group, with specific person (one of his contacts), or mark it Private (nobody sees it but him). In that view, it is possible to share Time-lines yet hide some of their content by defining specific per asset permission level rules, overriding the Time-line permission level rules.

On the Asset menu 58 (FIGS. 2, 7), the user can fill tag field bound to specific asset or Time-line with the previously assigned keywords thus granting the associated permission level rule to the contact entity, being a person or a group, assigned with that keyword. The tagged assets will be visible to anyone permitted to view the asset. The user can watch tags added by others to his assets. Additionally, on the Asset menu, the user can add comments and reminders visible to other users according to the permission level rules, and amend the Date of an asset (which is helpful when trying to decide when old pictures where taken, since the automatically assigned Date will be the date they were scanned).

All collected assets, linking tags and comments are stored in an asset repository 32, where AllofMe-service keeps a record of all users assets from all the different services, in a unified format.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

What is claimed is:

1. A method of long-term collecting, managing, secure sharing and archiving of valuable personal digital assets on a social network, comprising:
a. providing at least an on-line social network service, having at least dispatcher application and data storage capabilities;
b. providing a client interface;
c. using said client interface for becoming registered user of said social network service and perform tasks;
d. defining user sources and collect assets, the collected assets are chronologically organized as eternal Time-lines;
e. setting permission level rules associated with each asset and Time-line;
f. defining plurality of subjective groups distinguished by their relation to the user, and occupying each group with keywords assigned to its individual entities;
g. tagging chosen assets of said Time-line, with said assigned keywords, recognized by the social network service, thus sharing them with the tagged entity according to said permission level rules;
h. inviting and enabling authorized members to contribute and share assets with the founder of an established Time-line, and
i. optimizing said data storage, in a way that every tag added to an assets will appear on every instance it has on other Time-lines sharing that asset, such that shared assets will be saved to said data storage only once.

2. The method as claimed in claim 1, wherein said client interface is an on-line application located on the service.

3. The method as claimed in claim 1, wherein said client interface is a locally installed application program.

4. The method as claimed in claim 1, wherein account identities and security passwords, for said user defined sources are encrypted and stored for future synchronization.

5. The method as claimed in claim 1, wherein said service further includes a fetcher application program performing automatic seamless scheduled task of synchronization and assets collection from said user defined sources.

6. The method as claimed in claim 1, wherein said assigned keywords are personal E-mail addresses.

7. The method as claimed in claim 1, wherein said assigned keywords are names assigned to said entities on the social network service.

8. The method as claimed in claim 1, wherein said entities are chosen at least from the list of: persons; groups or Time-lines.

9. The method as claimed in claim 8, wherein said persons may include persons other than said social network members.

10. The method as claimed in claim 1, wherein an attribution comment is attached with said tag.

11. The method as claimed in claim 1, wherein the founder decides whether to accept a shared asset contributed to said founder's Time-line.

12. The method as claimed in claim 1, wherein the visibility of said Time-line may be zoomed by the user on the client interface, from one day in life to any given period of time.

13. The method as claimed in claim 12, wherein said Time-line is capable of being rolled as a movie presentation having a speed control.

14. A system for performing the method of claim 1, said system comprising:
a. a collection of digital assets stored on storage devices chosen at least from the group of: storage services; mail services; local disks; websites; dedicated social networks; address-books; contacts-lists or backup devices;
b. a social network service Internet site established and brought on-line;
c. at least one dispatcher application responsible for synchronization with said collection storage devices;
d. data storage repository;
e. at least one end device with Internet access;
f. a client interface application with registration and logging menus;
g. additional, service specific menus chosen at least from the group of: Services; Time-lines; Contacts; Shares or Assets.

15. The system as claimed in claim 14, wherein said client interface application is an on-line website with pages and forms.

16. The system as claimed in claim 14, wherein said client interface application downloaded and installed on said end device, is treated by said social network dispatcher as one of said collection storage devices.

17. The system as claimed in claim 14, wherein using said Services menu, a user passes to said dispatcher, authentication and identifications required to access said user's data on the collection storage devices.

18. The system as claimed in claim 17, wherein upon confirmation by said user, said authentications and identifications are encrypted and saved for future seamless scheduled automatic synchronization task of assets collection from said storage devices.

19. The system as claimed in claim 18, wherein the collection task is performed by a fetcher application and server located on said social network service.

20. The system as claimed in claim 14, wherein using said Time-lines menu, a user creates new tabbed branches and assigns assets thereto, said branches are chronologically organized and visualized as Time-lines, appearing as selectable tabs on the user's main page in said social network service website.

21. The system as claimed in claim 20, wherein said Time-line visualization permit zooming to various resolutions.

22. The system as claimed in claim 20, wherein said user further grants other users permissions to view assets in said user's Time-line.

23. The system as claimed in claim 20, wherein the user further grants other users permissions to manage assets in said user's Time-line.

24. The system as claimed in claim 14, wherein using said Contacts menu, a user imports the list of contacts from said storage devices, assigns a keyword to each contact, and creates or manages distinguished groups, populated with said contacts and assigned keywords, said groups are also assigned with keywords, visually represented as tabs in said user's page on said social network service website.

25. The system as claimed in claim 24, wherein the user associates different Time-lines to said distinguished groups, and wherein multiple Time-lines per group are permitted.

26. The system as claimed in claim 14, wherein using the Share menu, a user sets permission level rules by filling a permission field bound to each specific assets of said user's Time-line, with a permission level rule, said permission level rule is chosen at least from the group of: all; groups; contacts or privates.

27. The system as claimed in claim 26, wherein said permission field includes addition selection of permission level rules, chosen between view and manage.

28. The system as claimed in claim 26, wherein said permission field is bound to entire Time-line.

29. The system as claimed in claim 14, wherein using the Asset menu, a user fills a tag field bound to each specific asset of said user's Time-line, with at least one of said assigned keywords thus granting the permission level rule to said tagged entity.

30. The system as claimed in claim 29, wherein the tag field includes an additional comment field visible to other users according to said permission level rules.

31. The system as claimed in claim 14, wherein using the Asset menu, a user corrects the Date assigned to an asset.

32. The system as claimed in claim 14, wherein all collected assets, linking tags and comments are stored in said repository, thus keeping record of all users assets from all the different services, in a unified format.

33. The system as claimed in claim 14, wherein the Time-lines are edited simultaneously, by multiple users of said social network service, operating various end devices.

34. The system as claimed in claim 14, wherein using the Time-lines menu users and guests of said social network service, views other Time-lines according to the permission level rules associated with those Time-lines.

35. A program storage device readable by machine, tangibly embodying a program of instructions executable by the machine to perform a method of long-term collecting, managing, secure sharing and archiving of valuable personal digital assets on a social network, said method comprising:
a. providing at least an on-line social network service, having at least dispatcher application and data storage capabilities;
b. providing a client interface;
c. using said client interface for becoming registered user of said social network service and perform tasks;
d. defining user sources and collect assets, the collected assets are chronologically organized as eternal Time-lines;
e. setting permission level rules associated with each asset and Time-line;
f. defining plurality of subjective groups distinguished by their relation to the user, and occupying each group with keywords assigned to its individual entities;
g. tagging chosen assets of said Time-line, with said assigned keywords, recognized by the social network service, thus sharing them with the tagged entity according to said permission level rules;
h. inviting and enabling authorized members to contribute and share assets with the founder of an established Time-line, and
i. optimizing said data storage, in a way that every tag added to an assets will appear on every instance it has on other Time-lines sharing that asset, such that shared assets will be saved to said data storage only once.
